(19) United States
(12) Patent Application Publication
(10) Pub. No.: US 2017/0065063 A1
(43) Pub. Date: Mar. 9, 2017

(54) Collapsible Device Stand

(71) Applicant: Robert Ryan Freeman, Roseville, CA (US)

(72) Inventor: Robert Ryan Freeman, Roseville, CA (US)

(21) Appl. No.: 14/848,264

(22) Filed: Sep. 8, 2015

(51) Int. Cl. A45F 5/00; F16M 13/02; F16M 11/00

(52) U.S. Cl. CPC A45F 5/00; F16M 11/00; F16M 13/02; A45F 2200/0516; A45F 2200/0525; A45F 2200/0533; A45F 2200/0508

(57) ABSTRACT

A collapsible device stand with a large folding arm and a variable position spring loaded sliding rail carrier with a small folding arm. Primarily used for holding an object at an angle or vertically. This device can hold a mobile device, tablet, or cell phone from below or from the side. The sliding rail carrier locks into place by upwards force using friction between the rail carrier and main body track produced by one or more sliding rail carrier springs. This stand collapses completely into the main housing when both arms are folded down and the sliding rail arm is slipped into a cavity in the fixed position folding arm. The main housing cap includes a keychain hole. An optional configuration includes a tripod mounting socket used to mount this device to a tripod.

### CROSS-REFERENCE TO RELATED APPLICATIONS

Not Applicable

### BACKGROUND OF THE INVENTION

The invention is a compact and collapsible holder for relatively flat edged items. Particularly designed as a stand for mobile electronic devices such as smartphones, tablet computers, cellular phones, media players, cameras, and video cameras. The invention may also be used as a caliper, tripod adapter, or clamp.

Existing holders for electronic devices have the following shortcomings. First, they do not collapse into a rectangular object for convenient storage in a pocket or on a keychain. Second, they do not allow for both side mount and flat mount capability. Third, they do not allow for 90 degree flat mount capability with the keychain still attached. Fourth, they may be designed to block the device's ports. Fifth, they do not support a wide range of device widths. Finally, they are not designed for a tripod mount. This invention overcomes all these shortcomings and holds the device on any of its relatively flat edges, resulting in variable holding angles.

### BRIEF SUMMARY OF THE INVENTION

The invention is a collapsible device stand that may be attached to a keychain and carried in a pocket or purse. The invention includes 5 custom parts (FIG. 2A and FIG. 2B). These parts include: Part 1—Main Body; Part 2—Cap; Part 3—Rail Carrier; Part 4—Large Folding Arm; and Part 5—Small Folding Arm. Additional standardized parts include hinge pins, screws, glue, and a spring.

Paragraphs 0005 through 0011 describe the device usage.

The invention is designed to be attached to a keychain via the keychain hole in the Cap.

The invention is designed to be closed so that the Small Folding Arm slides into the Large Folding Arm providing a flush surface with the Main Body. This is accomplished by folding down both arms and then sliding the Rail Carrier towards the Large Folding Arm. In this configuration the invention may be stored In a pocket, backpack, purse, or other small container.

The invention is designed to be opened so that both arms are perpendicular to the Main Body. This is accomplished by depressing the Rail Carrier and sliding it towards the cap which releases the Small Folding Arm from the Large Folding Arm. The Large Folding Arm and Small Folding Arm are then rotated 90 degrees. The Rail Carrier is depressed and slid towards the Large Folding Arm until the appropriate width is achieved. In this configuration the invention acts as a variable width clamp that can be positioned to hold an object.

The invention may include ruled lines on either side so that the clamp position may be recorded. In this manner the invention is designed to be used as a caliper or ruler.

The invention is designed to hold a mobile device from the side so that it is perpendicular to the main body. In this configuration the mobile device faces away from the cap and can be positioned anywhere along the side of the mobile device, referred to as Use Case 1 (FIG. 3A and FIG. 3B). Varying the position along the side of the mobile device changes the angle at which the device is held. This angle goes up to 90 degrees vertical when positioned at the lowest point along the side of the mobile device.

The invention is designed to hold a mobile device from below so that it is perpendicular to the main body. In this configuration the mobile device may be facing towards the cap, referred to as Use Case 3 (FIG. 5A and FIG. 5B) or away from the cap, referred to as Use Case 2 (FIG. 4A and FIG. 4B). In this configuration the mobile device may be tilted slightly or held at 90 degrees.

The invention is designed to be attached to a standard personal camera mount, such as a tripod (FIG. 5B). In this configuration the invention acts as an adapter for a mobile device camera to attach to a standard camera mount. The mobile device may be held in Use Case 2 or Use Case 3 depending upon which side of the device the camera is located.

Paragraphs 0013 through 0021 describe the device assembly.

The Large Folding Arm is attached to the Main Body by a hinge pin allowing the Large Folding Arm to rotate 90 degrees within the Main Body.

The sliding Rail Carrier is installed into the Main Body by compressing the spring(s) while inserting the Rail Carrier into the top of the Main Body. After the Cap is installed, the Rail Carrier can slide from the Large Folding Arm to the Cap by way of a track inside the Main Body.

The Rail Carrier contains one or more springs on its underside that provide pressure between the Rail Carrier and the Main Body. This pressure increases the friction of the Rail Carrier against the top of the rail built into the Main Body. This friction prevents the Rail Carrier from sliding when the invention is holding an object.

The Small Folding Arm is attached to the Rail Carrier by a hinge pin allowing the Small Folding Arm to rotate 90 degrees relative to the Rail Carrier.

The Large Folding Arm has a flattened edge parallel to the hinge pin that lays flat against the Main Body when opened and prevents the arm from rotating further than 90 degrees.

The Small Folding Arm has a flattened edge parallel to the hinge pin that lays flat against the Main Body when opened and prevents the arm from rotating further than 90 degrees.

The Small Folding Arm also incorporates a protruding stop built into the Rail Carrier that provides additional support to prevent the Small Folding Arm from rotating further than 90 degrees.

The Cap is attached to the Main Body with glue and/or screws and provides a stop for the Rail Carrier in addition to a keychain hole.

The Main Body also includes a cutout below the keychain hole in the Cap so that the invention can be laid flat without having to remove the keychain.

### BRIEF DESCRIPTION OF THE SEVERAL VIEWS OF THE DRAWING

FIG. 1A is a top perspective view of the invention in the closed position.

FIG. 1B is a top perspective view of the invention with the Slide Rail depressed and slid to the open position.

FIG. 1C is a top perspective view of the invention in the clamped down position. This is the in use position.

FIG. 2A is a rear top perspective view of the custom components used in this invention. The parts are labelled with the following reference numbers: Part 1—Main Body; Part 2—Cap; Part 3—Rail Carrier; Part 4—Large Folding Arm; Part 5—Small Folding Arm; Part 101—Closed Spring; Part 102—Large Folding Arm Hinge Pin; Part 103—Small Folding Arm Hinge Pin; Parts 104—Cap Pins (quantity 2). FIG. 2A also depicts the following features: Feature 1A—Tripod Threaded Hole also described as Option 1; Feature 1B—Keychain Cutout; Feature 2A—Keychain Hole; Feature 3A—Raised Block; and Feature 5A—Small Folding Arm Cutout.

FIG. 2B is a front bottom perspective view of the custom components used in this invention. The parts are labelled with the following reference numbers: Part 1- Main Body; Part 2—Cap; Part 3—Rail Carrier; Part 4—Large Folding Arm; Part 5—Small Folding Arm; and Part 101—Closed Spring. FIG. 2B also depicts the following features: Feature 1A—Tripod Threaded Hole also described as Option 1; Feature 1B—Keychain Cutout; Feature 1C—Main Body Track; Feature 2A Keychain Hole; and Feature 3A—Raised Block.

FIG. 3A is a font perspective view of Use Case 1. In Use Case 1, the invention is mounted to the side of the held object at any position along the object's side. In this figure, Part 1 contains all other parts of the invention as a fully assembled unit. Object 99 represents the held object.

FIG. 3B is a rear perspective view of Use Case 1. In this figure, Part 1 contains all other parts of the invention as a fully assembled unit. Object 99 represents the held object.

FIG. 4A is a front perspective view of Use Case 2 with a horizontal object. In Use Case 2, the invention is placed below the held object with the object slightly tilted. In this figure, Part 1 contains all other parts of the invention as a fully assembled unit. Object 99 represents the held object.

FIG. 4B is a front perspective view of Use Case 2 with a vertical object. In this figure, Part 1 contains all other parts of the invention as a fully assembled unit. Object 99 represents the held object.

FIG. 5A is a front perspective view of Use Case 3. In Use Case 3, the invention is placed below the held object and slid closed completely so that held object is at a 90 degree angle to the invention. Use Case 3 is the primary photo taking position. In this figure, Part 1 contains all other parts of the invention as a fully assembled unit. Object 99 represents the held object.

FIG. 5B is a front perspective view of Use Case 3 with the device mounted to a tripod, object 98. This figure is only applicable to a device with Option 1. In this figure, Part 1 contains all other parts of the invention as a fully assembled unit. Object 99 represents the held object.

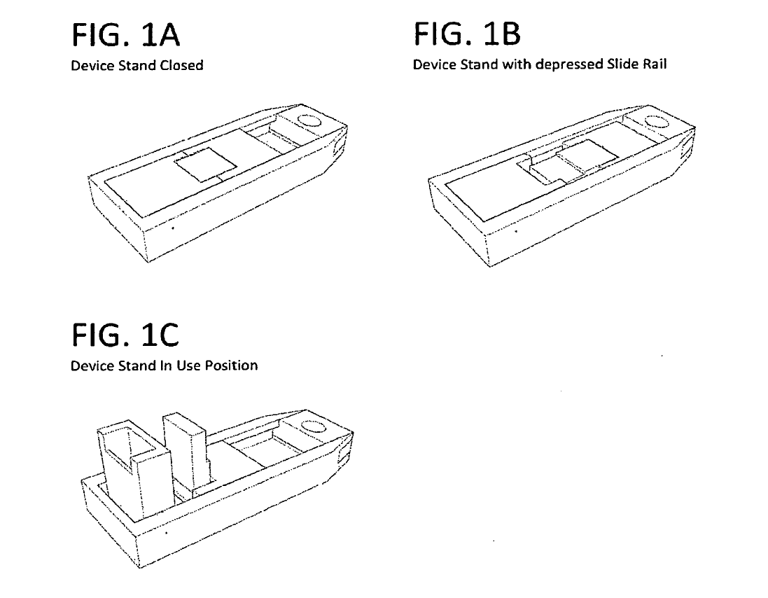

### DETAILED DESCRIPTION OF THE INVENTION

The following description shall not limit the scope of the invention. This will describe the best application of the invention known to the inventor as of the filing date hereof. Changes may be made in the configuration or function of any of the elements described herein without departing from the spirit and scope of the invention. Parts may be made from any material that can be molded, printed, or machined into hardened parts, including: metallic alloys; polymers; fiber reinforced polymers; ceramics; stones; and composite materials.

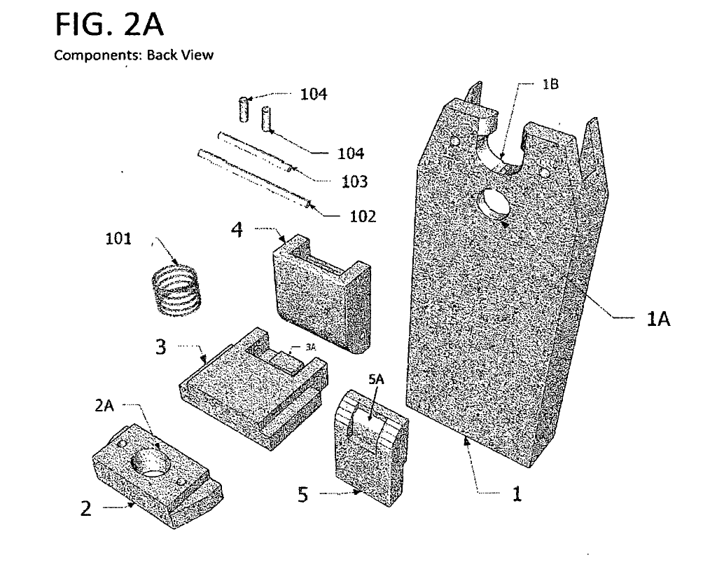

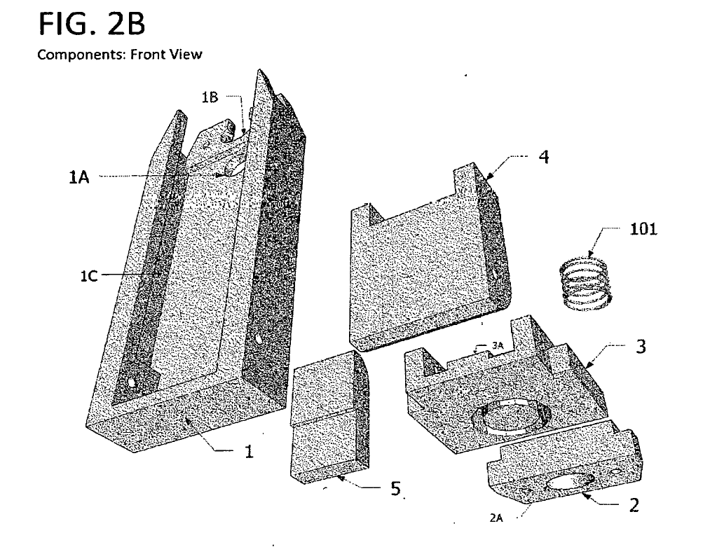

Paragraphs 0035 through 0039 describe the individual parts in FIG. 2A and FIG. 2B.

Part 1, the Main Body, is a rectangular housing with a Track (Feature 1C) cutout running the length of Part 1. Part 1 is open on the front to allow for Part 3 and Part 4 to be installed and manipulated from the front. Part 1 is closed on the back. Part 1 is closed on the bottom end and open on the top. The top is formed so that Part 2 fits flush to Part 1 when installed. The top of Part 1 is tapered at a slight angle from the side to better support an angled configuration in Use Case 1. Part 1 has a large hole at the top to allow a keychain to pass through. Part 1 has a cutout above and connected to the large keychain hole which allows Part 1 to lay flat when the keychain is attached in Use Case 2 and Use Case 3. In this manner Part 1 does not directly support an attached keychain as this function is relegated to Part 2. Part 1 has a drilled hole from side to side near the bottom for a hinge pin installed through Part 4. Part 1 may have 2 drilled holes near the top perpendicular to part 1 used to fasten Part 2 to Part 1. Alternatively, Part 2 may be fastened to Part 1 using adhesive or welds and would not need these holes. Any holes in this part may be threaded, glued, or welded to fasten the hinge pin or screws. Part 1 may or may not have an additional threaded hole located below the cap on the back side identified as Drawing Reference Number 1A for use by a typical camera or tripod mount. This will usually be a Whitworth ¼″ thread, but may be threaded for any mounting device.

Part 2, the Cap, is a trapezoidal block that fits flush into the top of Part 1. Part 2 has a large keychain hole drilled through the middle and is used to support the invention when connected via a keychain. Part 2 acts as a stop for Part 4, preventing Part 4 from sliding out of Part 1. Part 2 may or may not have 2 screw holes to attach to Part 1 as described in the Part 1 description,

Part 3, the Rail Carrier, is a square block with cut out rail edges on both sides so that Part 3 slides into Part 1 and has room to move up or down within the track. Part 3 has a recess on the bottom so that a spring may be installed underneath and provide upwards force so that Part 3 will act as a button and provide friction against the top of the track on Part 1. This friction prevents Part 3 from sliding unless it is being depressed. Part 3 has a recess at the front which is sized to hold the rounded end of Part 5. The recess has holes drilled from side to side so that a hinge pin can be installed to secure Part 5 to Part 3. Part 3 also has a raised stop in the recess that prevents Part 5 from rotating further than 90 degrees.

Part 4, the Large Folding Arm, is a rectangular block with a rounded bottom end and a cavity in the top end that the top of Part 5 fits within. In this way Part 5 slides into Part 4 when in the closed position. This creates a nearly flush surface with Part 1. Part 4 has a hinge pin hole drilled from side to side which is parallel to the rounded bottom, near the center of the curve. Part 4 sits within the bottom of Part 1 and is attached with a hinge pin. The rounded bottom allows for Part 5 to rotate 90 degrees until it hits a flattened edge at the end of the rounded bottom. At 90 degree rotation, Part 4 is perpendicular to Part 1. The arm may be sanded or coated to prevent the arms from scratching the held object and increase the grip on the held object.

Part 5, the Small Folding Arm, is a rectangular block with a rounded bottom end and an offset on the top end so that Part 5 fits within the Part 4 cavity when closed. Part 5 has a hinge pin hole drilled from side to side which is parallel to the rounded bottom, near the center of the curve. Part 4 sits within the front recess of Part 3 and is attached with a hinge pin. The rounded bottom allows for Part 5 to rotate 90 degrees until it hits a flattened edge at the end of the rounded bottom. At 90 degree rotation, Part 4 is perpendicular to Part 1. Part 5 has a cutout in the rounded bottom which provides a path for the Part 3 raised stop to travel until Part 5 reaches 90 degrees. The arm may be sanded or coated to prevent the arms from scratching the held object and increase the grip on the held object.

Paragraphs 0041 through 0042 describe the objects identified in the drawings that are not part of the invention. These represent objects with which the invention interfaces.

FIG. 58: Object 98, the Tripod, represents any standard photographic mount and is included to show how the invention attaches to a photographic mount. The threaded hole in Part 1 accepts a standard mounting screw from below. Object 98 has a flat mounting surface penetrated by a mounting screw. The mounting screw is turned clockwise to tighten Part 1 to the mounting surface. The mounting screw is turned counter-clockwise to release Part 1 from the mounting surface.

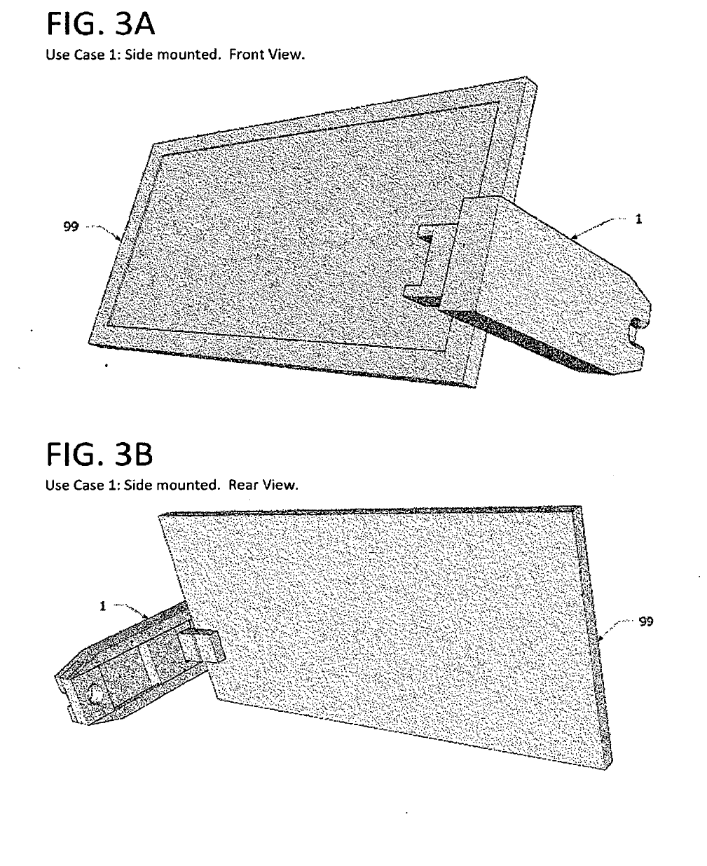

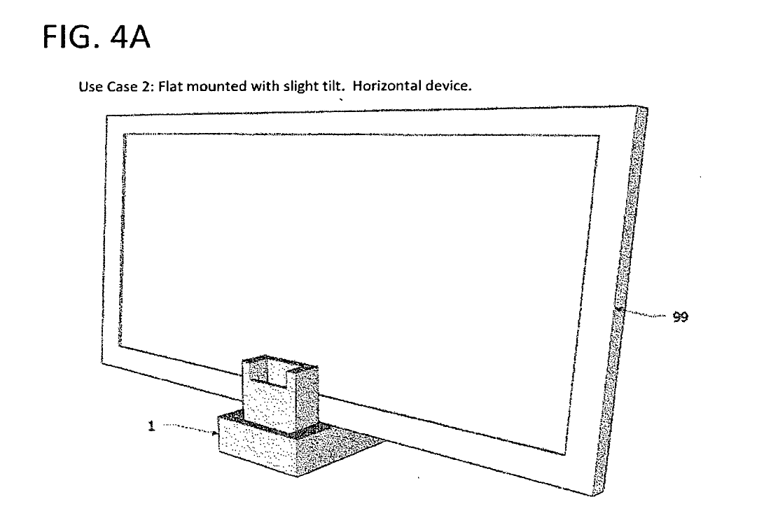

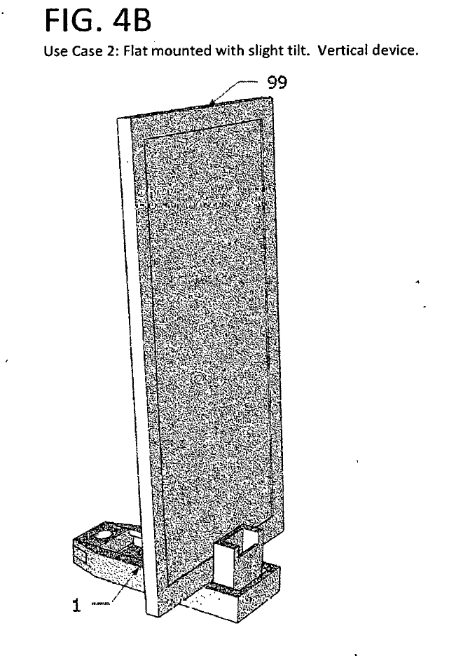

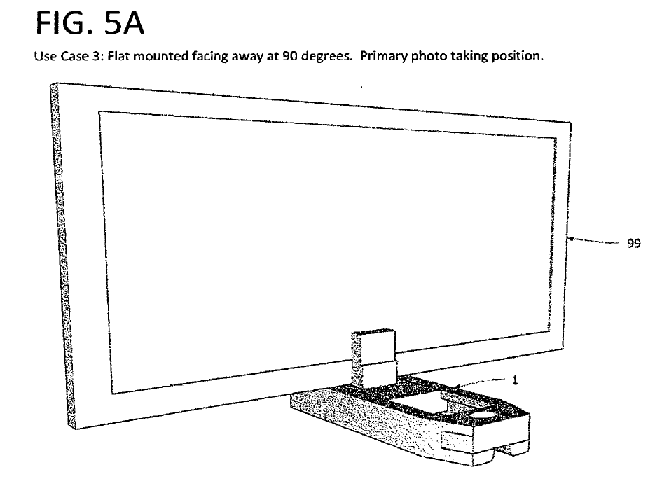

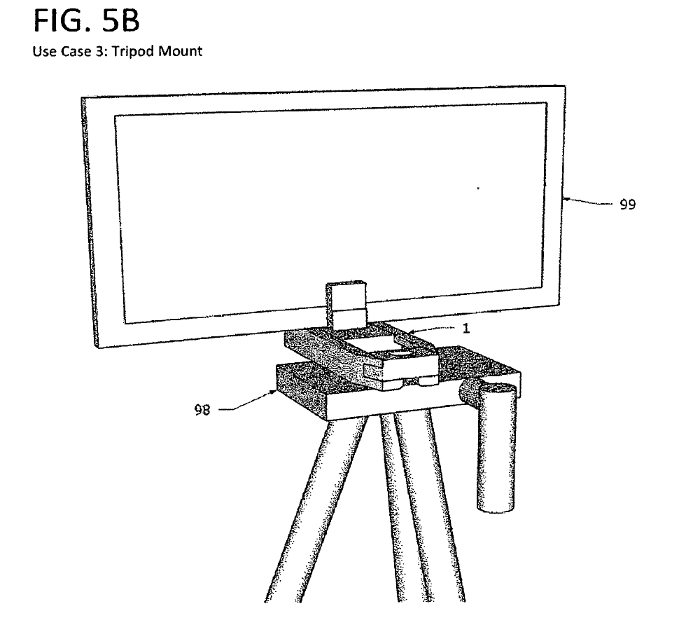

FIG. 3A, FIG. 3B, FIG. 4A, FIG. 4B, FIG. 5A, and FIG. 5B: Object 99 represents any object that can be held by the invention. This includes any object which has a rectangular or flat edge. Typically, this object will be a cellular phone, tablet, media player, cardboard, or several cards. Object 99 may feature a beveled, chamfered, or rounded edge. This edge feature should end before the point at which Part 4 or Part 5 contacts Object 99. Object 99 may be slightly curved.

Paragraphs 0044 through 0047 describe the parts identified in the drawings that are not unique to this invention but are included in the construction of this invention.

FIG. 2A: Object 101, the Closed Spring, is a closed and ground spring installed into the spring recess in Part 3.

FIG. 2A: Object 102, the Large Folding Arm Hinge Pin, is a straight hinge pin used to attach Part 4 to Part 1.

FIG. 2A: Object 103, the Small Folding Arm Hinge Pin, is a straight hinge pin used to attach Part 5 to Part 3.

FIG. 2A: Objects 104, the Cap Pins, are 2 straight pins used to attach Part 2 to Part 1.

The following are claimed:

1. A stand consisting of a fixed position folding arm and a variable position spring loaded sliding rail carrier with another folding arm held within a main body such that: both folding arms collapse within the main body; one arm slides into the other arm; the sliding rail carrier travels along a rail inside the main body; and the main body is capped so that the rail carrier cannot leave the main body track.

2. The stand of claim 1, wherein the sliding rail carrier includes one or more springs, including foam springs, leaf springs, spring loaded ball bearings, or a single closed spring installed below the rail carrier providing an upwards force against the main body track when it is not depressed in order to supply friction to prevent movement along the track.

3. The stand of claim 1, wherein the sliding rail carrier can be depressed and slid along the main body rail so that the small arm slides into or out of the main arm when the arms are collapsed flat within the main body.

4. The stand of claim 1, wherein the sliding rail carrier can be depressed and slid along the main body rail so that the arms clamp down or release the object to be held when the arms are opened perpendicular to the main body.

5. The stand of claim 1, wherein the arms rotate up to 90 degrees from their collapsed position within the main body.

6. The stand of claim 1, wherein the small arm is prevented from rotating further than 90 degrees by a raised block on the rail carrier and a corresponding cutout in the small arm rounded edge.

7. The stand of claim 1, wherein the cap contains a keychain hole.

8. The stand of claim 1, wherein the cap fits flush to the top of the main body.

9. The stand of claim 1, wherein the main body contains a threaded hole located just below the cap on the back side of the main body used to mount the stand to a tripod or camera mount and may be a ¼″ Whitworth thread or other standard mount size.

10. The stand of claim 1, wherein the arms are sanded or coated to prevent the arms from scratching the held object and to increase the surface grip on the held object.

11. The stand of claim 1, wherein the stand is clamped to the side of an electronic device in order to prop the device at an angle up to 90 degrees.

12. The stand of claim 1, wherein the stand is placed below the held object and clamped onto the bottom of the held object, holding it at 90 degrees if clamped tight or slightly tilted if clamped loosely.

13. The stand of claim 1, wherein the stand is tapered from the sides on the cap end so that the stand maintains a flat edge on the supporting surface when holding a device from the edge tilted at an angle equal to the taper angle.

14. The stand of claim 1, wherein the stand's main body contains a cutout under the cap extending from the keychain hole so that an attached keychain will not inhibit the stand from lying flat on a flat surface.
